(19) United States
(12) Patent Application Publication
(10) Pub. No.: US 2026/0109239 A1
(43) Pub. Date: Apr. 23, 2026

(54) SYSTEM, APPARATUS, AND METHOD FOR A MODULAR POWER SOURCE

(71) Applicant: SCOUT MOTORS INC., Tysons, VA (US)

(72) Inventors: Pat Vostal, Plymouth, MI (US); Niclas Meyer, Birmingham, MI (US); Lutz Kahl, Royal Oak, MI (US); Ramin Mirshab, Royal Oak, MI (US)

(21) Appl. No.: 18/923,355

(22) Filed: Oct. 22, 2024

(51) Int. Cl. B60L 50/62; B60K 5/12; B60K 11/02; B60R 16/02

(52) U.S. Cl. CPC B60L 50/62; B60K 5/12; B60K 11/02; B60R 16/0207

(57) ABSTRACT

Provided herein is a system, apparatus, and method for a modular power source that can operate to extend the range of a battery electric vehicle and/or power accessories. Embodiments provided herein may include a battery electric vehicle including: a vehicle frame; a high-voltage battery; at least one electric motor; a modular power source comprising: a subframe; an internal combustion engine mounted to the subframe; and a cooling system mounted to the subframe, where the cooling system is in fluid communication with the internal combustion engine, where the subframe is configured to attach to a vehicle frame, and wherein the subframe structurally supports the internal combustion engine and cooling system.

### BACKGROUND

Battery electric vehicles more generically referred to as electric vehicles (EVs) are in a vehicle segment that has seen widespread adoption in recent years and is predicted to continue to grow strongly in coming years. EVs are generally efficient and produce few if any emissions while driving. However, the EV charging infrastructure available in most countries substantially lags the petroleum fuel infrastructure and growth of the charging infrastructure struggles to keep pace with the rate of adoption of EVs. The required public EV charging infrastructure requires substantial investment to keep up with the growing number of EVs.

Lack of access to efficient charging stations and electric vehicle driving range are two primary concerns that slow EV adoption and hamper growth of the EV industry. Range anxiety, where an EV driver becomes anxious with respect to the remaining vehicle range based on battery charge level, can be detrimental to EV reputation and adoption. Range improvement is a challenge for manufacturers who are challenged to produce vehicles at price points similar to that of their conventional internal combustion engine (ICE) contemporaries as battery technology is expensive in both cost and vehicle weight.

### BRIEF SUMMARY

A system, apparatus, and method is therefore provided for a modular power source that can operate to extend the range of a battery electric vehicle and/or power accessories. Embodiments provided herein may include a battery electric vehicle including: a vehicle frame; a high-voltage battery; at least one electric motor; a modular power source comprising: a subframe; an internal combustion engine mounted to the subframe; and a cooling system mounted to the subframe, where the cooling system is in fluid communication with the internal combustion engine, where the subframe is configured to attach to a vehicle frame, and wherein the subframe structurally supports the internal combustion engine and cooling system.

The battery electric vehicle of an example embodiment further includes a pair of front wheels and a pair of rear wheels, where the subframe is configured to attach to the vehicle frame at or aft of a rear pair of wheels. According to some embodiments, the subframe, when mounted to the vehicle frame, does not limit a departure angle of the battery electric vehicle. According to some embodiments the modular power source is configured to at least one of charge the high-voltage battery or provide power to the at least one electric motor.

The battery electric vehicle of some embodiments further includes a wire harness, where the wire harness is configured to be connected between the modular power source and the high-voltage battery, where electricity from the modular power source is provided through the wire harness to the high-voltage battery. According to some embodiments the vehicle frame has two frame rails extending longitudinally along a length of the battery electric vehicle and two or more cross-members joining the two frame rails, where the subframe is configured to mount to the two frame rails of the vehicle frame.

According to certain embodiments, the modular power source is installed in operational connection to the battery electric vehicle with a fuel connection and a wire harness connection. According to some embodiments the subframe, when mounted to the vehicle frame, defines at least a portion of a crash absorbing structure of the battery electric vehicle. The subframe of some embodiments further comprises a subframe cross member that includes a receiver tube for receiving at least one of a ball mount or hitch-mount accessory.

The modular power source of some embodiments further includes an exhaust system, where the exhaust system is configured to direct engine exhaust away from the vehicle frame. According to some embodiments the subframe, mounted to the vehicle frame, extends below the vehicle frame. According to certain embodiments the modular power source is removable without impacting roadworthiness of the battery electric vehicle. The battery electric vehicle of some embodiments functions as a pure electric vehicle with the modular power source removed.

Embodiments provided herein include a modular power source for a battery electric vehicle including: a subframe; an internal combustion engine mounted to the subframe via one or more vibration isolating engine mounts; and a cooling system mounted to the subframe, where the cooling system is in fluid communication with the internal combustion engine, wherein the subframe is configured to attach to a vehicle frame, and where the subframe structurally supports the internal combustion engine and cooling system. According to some embodiments the subframe is configured to attach to the vehicle frame at or aft of a rear pair of wheels.

The modular power source of some embodiments further includes a generator, where the internal combustion engine is configured to drive the generator to produce electricity. The modular power source of some embodiments further includes a wire harness configured to be connected to the battery electric vehicle, wherein the electricity from the generator is provided through the wire harness to a battery of the battery electric vehicle.

According to some embodiments the subframe is configured to mount to both frame rails of the vehicle frame having two frame rails extending longitudinally along a length of the battery electric vehicle and two or more cross-members joining the two frame rails. The subframe of an example embodiment includes at least one subframe cross member, and where when the subframe is attached to the vehicle frame, the at least one subframe cross member spans the two frame rails of the vehicle frame. According to some embodiments the subframe cross member comprises a receiver tube for receiving at least one of a ball mount or hitch-mount accessory.

### BRIEF DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 illustrates a diagram of a profile of a battery electric vehicle according to an example embodiment of the present disclosure;

FIG. 2 illustrates a diagram of a top view of a battery electric vehicle according to an example embodiment of the present disclosure;

FIG. 3 illustrates a partial top-view of a rear end of a battery electric vehicle according to an example embodiment of the present disclosure;

FIG. 4 illustrates a modular power source for a battery electric vehicle as mounted to the vehicle frame according to an example embodiment of the present disclosure;

FIG. 5 illustrates a modular power source for a battery electric vehicle according to an example embodiment of the present disclosure;

FIG. 6 illustrates another view of the modular power source for a battery electric vehicle according to an example embodiment of the present disclosure;

FIG. 7 illustrates still another view of the modular power source for a battery electric vehicle according to an example embodiment of the present disclosure;

FIG. 8 illustrates yet another view of the modular power source for a battery electric vehicle according to an example embodiment of the present disclosure; and

FIG. 9 illustrates a diagram of a profile of a battery electric vehicle with a modular power source installed according to an example embodiment of the present disclosure.

### DETAILED DESCRIPTION

Some embodiments of the present disclosure will now be described more fully hereinafter with reference to the accompanying drawings, in which some, but not all, embodiments are shown. Indeed, various embodiments of the present disclosure may be embodied in many different forms and should not be construed as limited to the embodiments set forth herein; rather, these embodiments are provided so that this disclosure will satisfy applicable legal requirements. Like reference numerals refer to like elements throughout.

Original development of the automobile in the late 19^{th} and early 20^{th} centuries saw the use of steam power, electric power, and fossil fuel power such as gasoline. Gasoline powered vehicles eventually became the overwhelming choice of manufacturers and buyers. However, in more recent years, a variety of power types have become more favorable to many buyers as technology has advanced. It is now common for vehicles to use electric power for propulsion.

Several vehicle types employ electric propulsion using batteries and electric machines (e.g., electric motors). Hybrid electric vehicles (HEVs) are vehicles that generally employ a relatively small high voltage (>100 volts) battery supplying energy to one or more electric motors to drive the wheels. HEVs also include an auxiliary power unit (APU) that generally includes an internal combustion engine to recharge and maintain charge of the battery. HEVs require the APU as their batteries generally do not support a range of more than 50 miles, and often less than 25 miles. Plug-in Hybrid Electric Vehicles (PHEVs) are similar to HEVs but offer the option for a user to plug the vehicle in to charge the modest battery. Battery electric vehicles (BEVs) are purely electrically propelled vehicles that do not rely on an APU and generally have a considerably larger battery than HEVs and PHEVs, such that the range of a BEV generally rivals that of their gasoline or diesel contemporaries.

In the infancy of vehicles or automobiles powered by internal combustion engines the availability of fuel was challenging and limited the range of these vehicles to the distance they could travel based on the amount of fuel they could carry. Gradually, petroleum fueling stations were built to accommodate the burgeoning age of mass-produced vehicles. Eventually, petroleum fueling stations became ubiquitous allowing travelers to drive a vehicle to virtually any location reachable by roadways without concern for where they may obtain fuel along the way.

Battery electric vehicles in their relative infancy experienced the same issues experienced at the infancy of the internal combustion engine powered vehicle. Electric charging stations are not yet ubiquitous in all areas, and demand outstrips availability in many regions. The BEV charging infrastructure has not kept up with the rapid development and growth of BEVs in many countries, hindering the adoption and growth of the BEV market.

Vehicle range is a critical limitation of BEVs. There remain regions that lack sufficient BEV charging infrastructure which makes travel within those areas challenging for drivers of BEVs. Further, the reliability of the charging infrastructure including charging stations that are not fully functioning is an issue with many older charging stations. As such, it is desirable to increase the range of BEVs to enable them to more freely travel while reducing user concerns regarding vehicle range. One mechanism to increase range is to increase the size and capacity of a battery. However, batteries are heavy and expensive, such that an increase in battery capacity often comes with a significant cost increase for a vehicle and a weight penalty which cuts against the range increase.

Embodiments provided herein provide a modular power source that can be easily mounted to the superstructure of a BEV. The modular power source may be referred to as a range extender or REX, as it extends the range of the BEV. The modular power source is able to charge the battery of a BEV to extend the range and/or provide power (e.g., in the form of electrical energy, mechanical energy, etc.) to one or more motors (e.g., the electric machines). In some embodiments, both the modular power source and the battery provide power to the motors (e.g., in series, in parallel, etc.). Conventional electric vehicles may not include a modular power source. Therefore, the inclusion of the modular power source in the BEV may offer performance improvements compared with conventional electric vehicles because the BEV with the modular power source may power the electric machines via the battery and/or the modular power source. Embodiments described herein include a modular power source that is removably attached to a vehicle frame in a manner that can be performed during production of a vehicle on an assembly line, or added to a vehicle after manufacture, such as at a dealer as an accessory or as a retrofit to a used vehicle. The components and structure of a vehicle required to enable fit and function of the modular power source to the vehicle are relatively minimal such that they do not add significant expense to a vehicle and can be made common to all vehicles of a particular model whether the vehicle is intended to receive the modular power source during production or not. The modular power source of embodiments is essentially a plug-and-play module that does not require considerable time or customization of a vehicle for implementation.

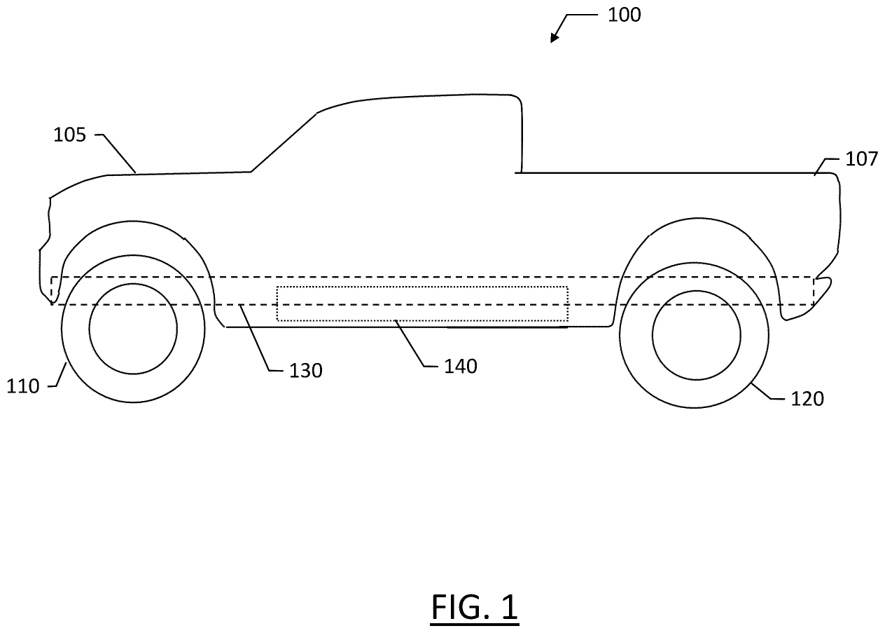

The diagram of FIG. 1 illustrates an example embodiment of a BEV 100 as described herein. The illustrated embodiment comprises a truck or pickup truck having a bed 107. While the illustrated embodiment includes a truck, embodiments can optionally include a car, sport utility vehicle, rugged sport utility vehicle, crossover vehicle, commercial vehicle, etc. The embodiments described herein are not intended to limit the type of vehicle that can benefit from the modular power source described herein.

The BEV 100 of FIG. 1 is illustrated to include front wheels 110 and rear wheels 120 and depicted in dashed lines is a general position and shape of a vehicle frame 130. Vehicle frames can be complex in shape; however, the illustrated vehicle frame 130 is a simplified example of a vehicle frame that extends longitudinally along a length of the BEV 100 in a body-on-frame arrangement where the body 105 of the vehicle and the bed 107 are mounted atop the vehicle frame 130. In some embodiments, the vehicle frame can be contoured with different elevations to allow for lowing the vehicle with respect to the wheels and suspension on which the wheels travel. While many vehicles, and particularly passenger cars, use generally a unibody structure, embodiments described herein relate to vehicles that include at least a portion of a frame structure. Vehicles can include a hybrid structure, such as a unibody structure for the passenger compartment or middle of the vehicle with frame rails extending fore and aft in a unitized platform-type frame. Embodiments described herein can be employed in such a unitized platform-type frame with the modular power source attached to a frame portion of the structure.

FIG. 1 also depicts a conventional general position of a battery 140 for a BEV 100. The battery 140, also sometimes referred to as a battery pack, high-voltage battery assembly, or traction battery, is a heavy component of the vehicle such that positioning the battery 140 in a central, low position provides improved handling and stability characteristics of the vehicle. Further, positioning the battery 140 in a central position in a BEV 100 provides the battery a safer location as vehicle accidents often occur at a front or rear of the vehicle.

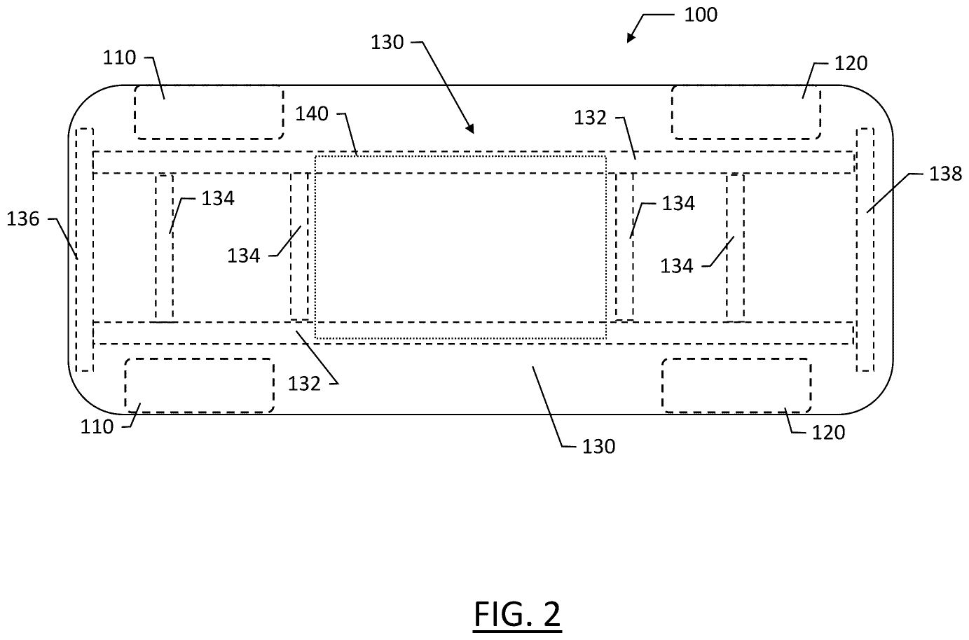

The diagram of FIG. 2 illustrates a top view of the BEV 100 with the vehicle frame 130 depicted in dashed lines. As shown, the vehicle frame 130 is positioned between the two front wheels 110 and between the two rear wheels 120. The vehicle frame 130 includes one or more frame rails 132 which extend longitudinally along a length of the BEV 100 and cross members 134 which extend between the two frame rails 132. Also shown is a front bumper bar 136 and rear bumper bar 138 attached to the frame rails 132. The battery 140 position is shown generally by the dotted line.

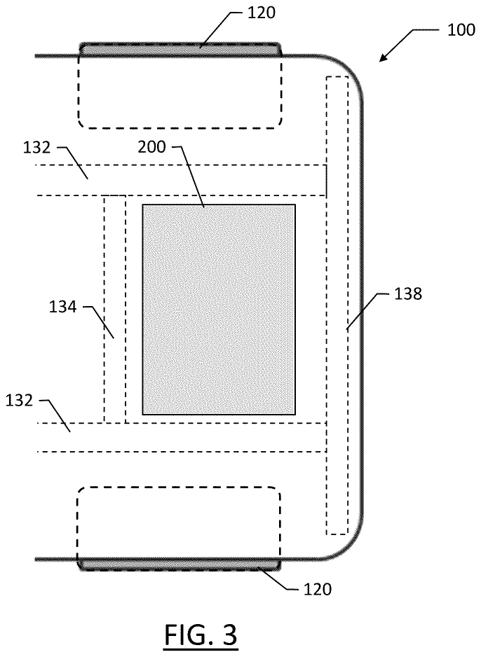

The diagram of FIG. 3 illustrates a partial view of a rear portion of the vehicle frame including frame rails 132 and rear wheels 120 along with cross member 134 and rear bumper bar 138. Also shown is the general relative size and position of a modular power source 200. The modular power source 200 of an example embodiment described herein is positioned between the frame rails 132 proximate a rear end of the vehicle and mounted securely to the frame rails. Embodiments provide an easily installed/removed module that can provide auxiliary power for a variety of purposes, including for charging a battery 140 of the BEV 100 and/or providing power (e.g., in the form of electrical energy, mechanical energy, etc.) to one or more motors (e.g., the electric machines) that propel the BEV to extend the range of the vehicle.

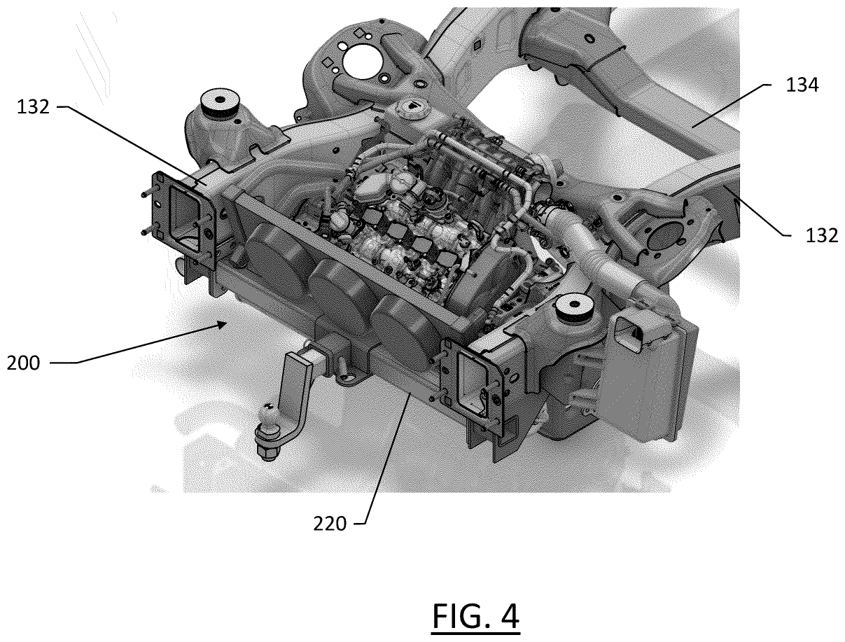

FIG. 4 illustrates a detail view of a rear portion of the vehicle frame including frame rails 132 and cross member 134 with the rear bumper bar omitted for viewing of the modular power source 200. The modular power source 200 is carried on a subframe, described further below, and the subframe is secured to the vehicle frame. As shown, the modular power source is secured to the vehicle frame and in the illustrated embodiment includes a subframe cross member 220. Positioning the modular power source 200 aft of the rear wheels minimizes noise from the engine reaching passengers of the BEV 100 as the noise escapes from the back of the vehicle as it moves forward along its path.

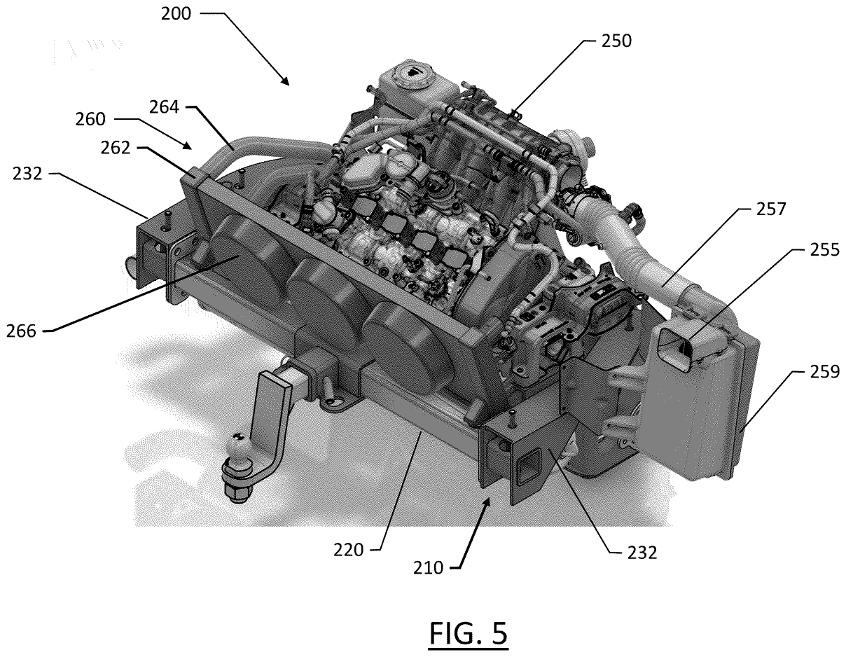

FIG. 5 illustrates the modular power source 200 with the vehicle frame omitted to more clearly show the subframe 210 which includes the subframe cross member 220. The subframe 210 includes subframe rails 232 which provide rigid support for the modular power source 200 including the internal combustion engine 250. The internal combustion engine 250 is secured to the subframe 210 along with air intake 255 which includes an intake tube 257 leading from an intake air filter 259 to the internal combustion engine 250. The internal combustion engine 250 employed in the modular power source 200 of example embodiments can be significantly smaller (e.g., smaller displacement volume) than an engine that would conventionally be used to drive the wheels of a conventional vehicle as the internal combustion engine 250 is used in a different manner. Conventional vehicle engines require sizing based on a vehicle mass and need to provide motive force across the powerband of the engine. This requires that even at the lowest power/torque on the powerband of engine, the engine still needs to provide sufficient power/torque to move the vehicle at a reasonable pace. The internal combustion engine 250 of example embodiments described herein are not so limited, as it will operate only in a narrow portion of the powerband since operation will be substantially limited to peak efficiency of the engine.

The internal combustion engine 250 generates heat such that a cooling system 260 is included in the modular power source 200. The cooling system 260 is a liquid cooling system that flows a liquid coolant between a radiator 262 and the engine via radiator hoses 264. The radiator 262 of the illustrated embodiment further includes fans 266 to force air through the radiator 262 to improve cooling efficiency. The modular power source 200 subframe unit includes provisions to provide a dedicated cooling systems 260 for the engine. This cooling system 260 can be separate from a cooling system of the vehicle which may be used to cool the battery. This enables the modular power source 200 to be a complete module that does not require complex integration with mechanical systems of the vehicle.

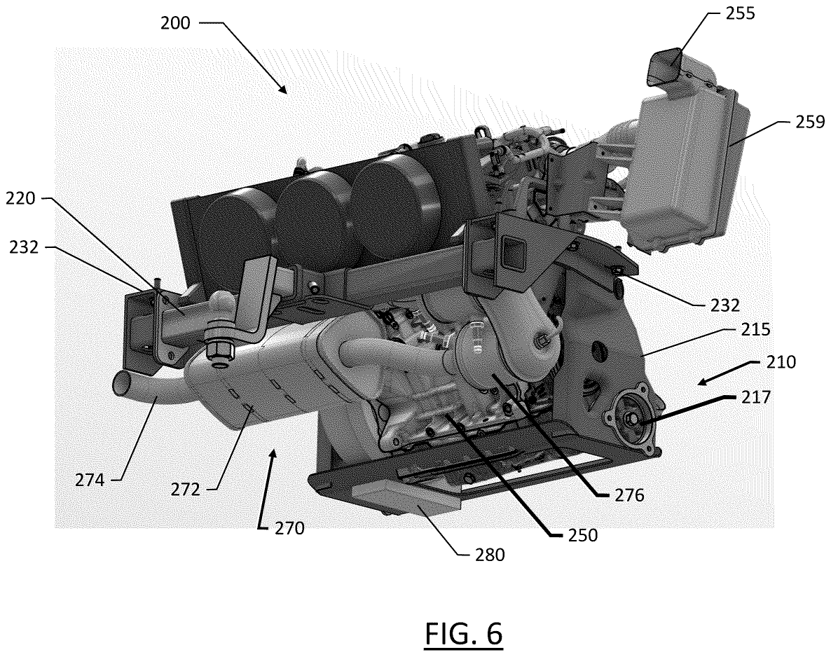

While FIG. 5 illustrates a view from above the modular power source 200, FIG. 6 illustrates a view from below the modular power source 200. Visible in FIG. 6 is the subframe 210 including the frame rails 232, which attach to the frame rails of the vehicle frame. FIG. 6 further depicts the subframe cradle 215 which supports the internal combustion engine 250 and is secured to the frame rails 232 of the subframe 210. In the illustrated embodiment the internal combustion engine 250 includes an inline-four cylinder engine that has an axis along which the pistons travel. As the largest dimension of an inline-four cylinder engine is generally along the same axis along which the pistons travel, tilting the engine relative to that axis remaining vertical reduces an overall height required by the engine, thus introducing packaging flexibility. The axis of the engine may be mounted at any angle within 0-50 degrees to ensure protection of the vehicle's overall dimensions. This includes ground clearance and departure angles, breakover and approach angles. The engine packaging design of example embodiments described herein includes a unique oiling system to accommodate the engine angle to support on and off road use of the range extending unit. The internal combustion engine 250 may be mounted to the cradle 215 of the subframe 210 using vibration isolating mounts 217. Isolating the engine vibrations from the subframe allows the subframe to be rigidly mounted to the vehicle frame. Also shown is the engine exhaust 270 which extends from an exhaust manifold, though one or more catalytic converters 276, through a muffler 272 and out an exhaust pipe 274. The modular power source 200 also includes a generator 280 which is coupled to the internal combustion engine 250.

The modular power source 200 employs the internal combustion engine 250 to drive the generator 280 which produces alternating current (AC) power. This converts mechanical rotational power output from the internal combustion engine 250 to electrical power. As the high-voltage battery of the vehicle is direct current (DC), the AC power output from the generator is input to an AC-to-DC converter attached to the generator 280 to produce DC power output. This DC power output from the converter is then used to charge the battery and/or provide power to one or more motors (e.g., the electric machines).

The modular power source 200 functions by running the internal combustion engine 250, fueled by conventional fuel (e.g., gasoline, diesel, ethanol, etc.), which spins the generator 280 to produce electricity. The amount of electricity produced, and the voltage thereof can be configured by application. Further, because the internal combustion engine 250 is not directly driving the wheels, the internal combustion engine 250 can run at peak efficiency when it is running to maximize the amount of electricity produced relative to the amount of fuel consumed, or at selected fixed levels based on an operating mode of the vehicle to provide the desired amount of energy most efficiently for that operating mode.

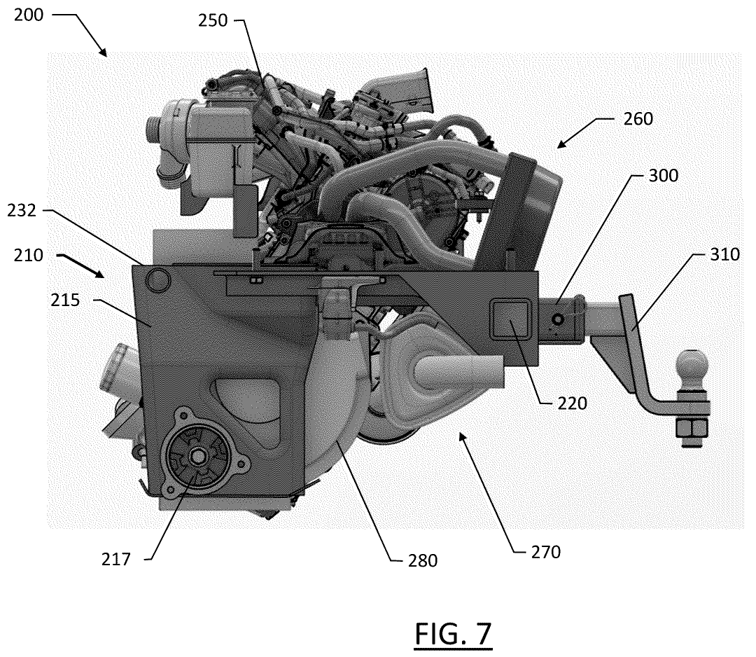

FIG. 7 illustrates a left-side view of the modular power source 200 better illustrating the subframe 210 and cradle 215 along with the vibration isolating mount 217 to which the internal combustion engine 250 and generator 280 are mounted. The subframe cross member 220 is shown in profile; however, more clearly illustrated in the embodiment of FIG. 7 is the receiver 300 which is integrally formed or mounted to the subframe cross member 220. In the depicted embodiment, a ball mount 310 is received in the receiver 300. However, any hitch-mounted accessory could be installed as needed. The inclusion of the receiver 300 as part of the subframe 210 demonstrates the structural rigidity of the subframe 210 and how when mounted to the vehicle frame, the subframe becomes part of the structure of the vehicle. As the subframe is a structural member of the vehicle when installed, the receiver 300 can be included as the load carried at the receiver 300 is transmitted to the vehicle frame through the structure of the subframe.

The use of a subframe cross member 220 sufficiently sized and configured for integration of the receiver 300 reduces the number of separate components for a vehicle and reduces the number of fasteners and attachment points at the frame. While the subframe cross member 220 could be reduced in size and rigidity while still being sufficient to support the internal combustion engine 250, it would require a separate tow bar to be attached to the frame and increase the time for assembly while also increasing weight with additional components. Further, the subframe cross member 220 as securely fastened via the subframe to the vehicle frame improves crash protection and overall vehicle rigidity which can benefit noise, vibration, and harshness that is detrimental to passenger comfort.

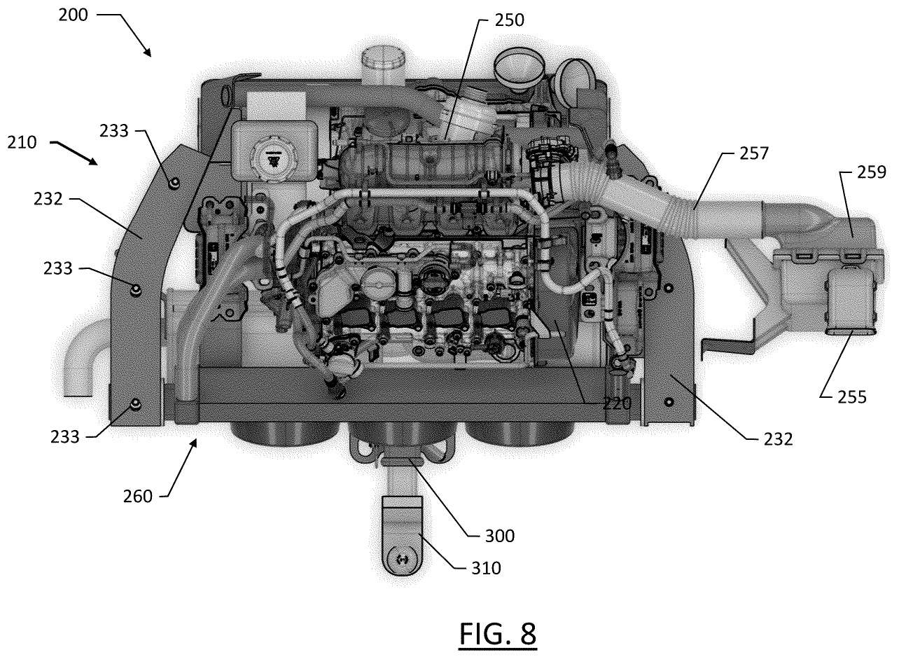

FIG. 8 illustrates a top view of the modular power source 200 more clearly illustrating the subframe rails 232 that attach to the vehicle frame. The subframe rails 232 of the illustrated embodiment are designed to attach along a substantial portion of their length to the vehicle frame such that the subframe rails 232 are a shape complementary to the vehicle frame. As shown, the subframe rails 232 can be secured to the vehicle frame rails with a limited number of fasteners 233 which in the illustrated embodiment include three fasteners 233 on each subframe rail 232. This promotes ease of installation and efficiency of the installation process. Further, the limited number of fasteners enables efficient disconnection of the subframe from the vehicle frame in the event a modular power source 200 is to be removed. The robust attachment between the subframe rails 232 and the vehicle frame ensures the structural rigidity of the connection between the vehicle frame and the subframe 210.

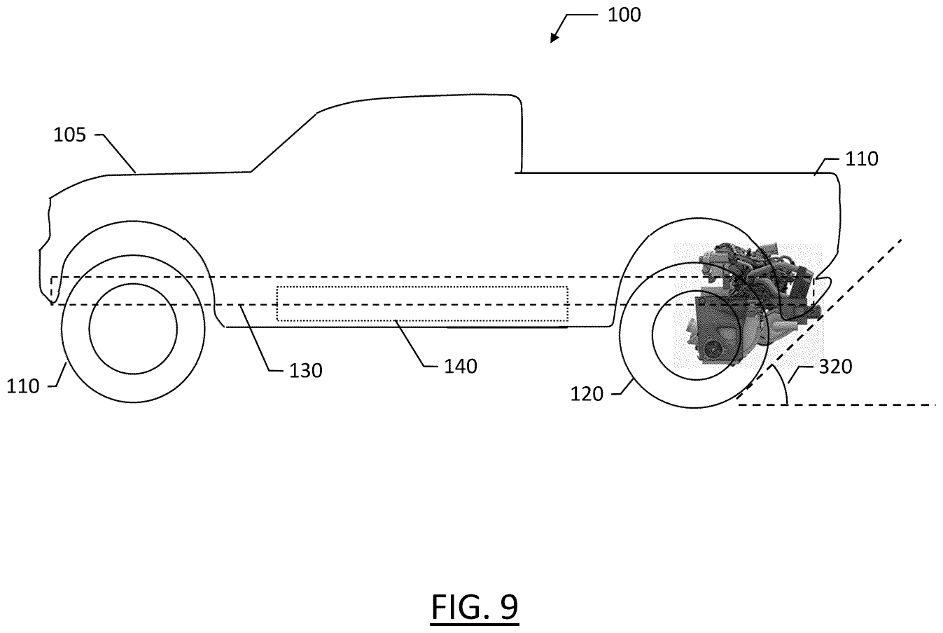

The modular power source 200 of example embodiments is structured in a manner that maintains vehicle performance and functionality when installed. Further, the structural rigidity of the modular power source enhances crashworthiness of the vehicle by incorporating additional weight and structure into the vehicle. FIG. 9 illustrates a diagram of the position of a modular power source 200 of embodiments described herein within a BEV 100. As shown, the modular power source is positioned low within the vehicle, which lowers the center of gravity for improved performance and stability, while also being low enough to be positioned below a truck bed 107. In the case of a different type of vehicle, such as a sport utility vehicle, the low position may allow the modular power source 200 to be below a load floor of a cargo area of the vehicle. The modular power source can be placed anywhere in the vehicle as long as space is available and air for cooling can be provided as needed and exhaust is safe to eject. However, mounting the modular power source aft of the rear wheels has several advantages detailed further below.

The modular power source 200 mounted aft of the rear wheels 120 as shown in FIG. 9 further provides improved crashworthiness with the added structure of the subframe 210 and subframe cross member 220. Crash protection is improved through an isolation mass at least partially aft of the rear wheels which can absorb energy during an impact at a rear end of the vehicle. The structure of the cradle 215 and subframe 210 being positioned at and below the frame of the vehicle also improves safety of a vehicle impacting the vehicle having the modular power source installed. Sport utility vehicles and pickup trucks have frames that may sit higher than some low vehicle such as sports cars. In the event of a rear impact on the BEV of example embodiments by a lower vehicle, the modular power source 200 can help prevent such a lower vehicle from going under the BEV, improving safety for both vehicles involved in the impact.

The cradle 215 of the subframe and the position of the components of the modular power source 200 also are configured to maintain the departure angle of the BEV 100. For vehicles that drive in terrain such as off-road vehicles including vehicles traveling off-road for job sites, the approach and departure angles are key features of a vehicle. These angles define at what angle a part of the vehicle precludes the vehicle wheels from maintaining full contact with the terrain. The departure angle, depicted in dashed lines as angle 320 in FIG. 9, is maintained at about 45° in the illustrated embodiment with the modular power source 200 not interfering with the departure angle of the vehicle itself. FIG. 9 illustrates the modular power source 200 without the ball mount as a user would remove the ball mount if concerned about departure angle. The subframe can include or be configured to receive skid plates or sheet metal sides that can protect the modular power source from contact with the ground and debris. These skid plates can be configured to protect the modular power source while not interfering with the operation of the internal combustion engine, such as by not shielding the radiator.

Not shown in the embodiments of FIGS. 3-9 is a fuel tank for holding fuel for the internal combustion engine 250 of the modular power source 200. A fuel tank may be mounted separately from the modular power source in a safe location that is protected by vehicle structure from impact. Fuel lines from the tank may extend along or within the vehicle frame to the modular power source for connection to the modular power source upon installation. The modular power source may also include a wire harness, the wire harness providing several aspects of functionality to the modular power source 200 and for conveying electricity generated at the modular power source 200 to the vehicle 100.

The wire harness of an example embodiment can be wired to a vehicle network architecture such that demand for auxiliary power may be commanded through the wire harness to start the internal combustion engine to begin generating power. This signal may be received automatically by the vehicle according to settings (e.g., when range is below a predefined amount) or upon user activation. Internal combustion engines require rotation of the engine to start the engine. While the modular power source could include a battery (e.g., a battery that can be recharged by the vehicle or by an alternator at the engine or by the generator), to conserve size, a starter motor of the engine may be powered through the wire harness thereby not requiring a starting battery on the modular power source. The wire harness may also be used to send and receive diagnostic information for the modular power source, such as engine temperature, generator output levels, engine speed, etc.

According to example embodiments described herein, the modular power source can be attached to a vehicle frame using fasteners such as bolts, and once attached, requires only the wire harness and fuel lines to be connected to be fully operational. This ease of installation renders the modular power source a useful accessory for the vehicle which can be installed on the assembly line or in the field and retrofitted on vehicles that were produced without the modular power source. The modular power source of an example embodiment can be assembled and tested independently of the BEV, such as at a different manufacturing facility or on a separate assembly line. The functionality of the modular power source can be tested at the conclusion of such manufacturing to ensure functionality ahead of installation into a vehicle. This separate manufacturing can minimize complexity at the vehicle assembly line and can maintain a manufacturing line that is free of fluid fuel to reduce the complexities and safety measures required where fluid fuel is present and used on an assembly line.

The modular power source is substantially a self-contained power source that requires minimal vehicle connections for complete functionality. Everything needed for the modular power source other than fuel supply is part of the module, such that upon fastening the subframe rails to the vehicle frame rails as described with respect to FIG. 8, the only remaining connections necessary include the fuel line and the wire harness. This renders the modular power source easily installed and removed with minimal time and effort. The modular power source may be removed from the BEV without impacting roadworthiness of the vehicle as the BEV would maintain pure electric functionality without the range extending modular power source.

Optionally, additional connections can be employed for some embodiments, such as if the cooling system is to be shared by a vehicle cooling system (e.g., battery cooling system) where the coolant lines of the internal combustion engine could be plumbed to the vehicle cooling system. Further, the air intake of some embodiments can be fastened to the vehicle in some embodiments in which an air intake is positioned at a particular location.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A battery electric vehicle comprising:
a vehicle frame;
a high-voltage battery;
at least one electric motor;
a modular power source comprising:
a subframe;
an internal combustion engine mounted to the subframe; and
a cooling system mounted to the subframe, wherein the cooling system is in fluid communication with the internal combustion engine,
wherein the subframe is configured to attach to a vehicle frame, and wherein the subframe structurally supports the internal combustion engine and cooling system.

2. The battery electric vehicle of claim 1, further comprising a pair of front wheels and a pair of rear wheels, wherein the subframe is configured to attach to the vehicle frame at or aft of a rear pair of wheels.

3. The battery electric vehicle of claim 1, wherein the subframe, when mounted to the vehicle frame, does not limit a departure angle of the battery electric vehicle.

4. The battery electric vehicle of claim 1, wherein the modular power source is configured to at least one of charge the high-voltage battery or provide power to the at least one electric motor.

5. The battery electric vehicle of claim 4, further comprising a wire harness, wherein the wire harness is configured to be connected between the modular power source and the high-voltage battery of the battery electric vehicle, wherein electricity from the modular power source is provided through the wire harness to the high-voltage battery.

6. The battery electric vehicle of claim 1, wherein the vehicle frame has two frame rails extending longitudinally along a length of the battery electric vehicle and two or more cross-members joining the two frame rails, wherein the subframe is configured to mount to the two frame rails of the vehicle frame.

7. The battery electric vehicle of claim 6, wherein the modular power source is installed in operational connection to the battery electric vehicle with a fuel connection and a wire harness connection.

8. The battery electric vehicle of claim 6, wherein the subframe, when mounted to the vehicle frame, defines at least a portion of a crash absorbing structure of the battery electric vehicle.

9. The battery electric vehicle of claim 6, wherein the subframe comprises at least one subframe cross member comprising a receiver tube for receiving at least one of a ball mount or hitch-mount accessory.

10. The battery electric vehicle of claim 1, wherein the modular power source further comprises an exhaust system, wherein the exhaust system is configured to direct engine exhaust away from the vehicle frame.

11. The battery electric vehicle of claim 1, wherein the subframe, mounted to the vehicle frame, extends below the vehicle frame.

12. The battery electric vehicle of claim 1, wherein the modular power source is removable without impacting roadworthiness of the battery electric vehicle.

13. The battery electric vehicle of claim 12, wherein the battery electric vehicle functions as a pure electric vehicle with the modular power source removed.

14. A modular power source for a battery electric vehicle comprising:
a subframe;
an internal combustion engine mounted to the subframe via one or more vibration isolating engine mounts; and
a cooling system mounted to the subframe, wherein the cooling system is in fluid communication with the internal combustion engine,
wherein the subframe is configured to attach to a vehicle frame, and wherein the subframe structurally supports the internal combustion engine and cooling system.

15. The modular power source of claim 14, wherein the subframe is configured to attach to the vehicle frame at or aft of a rear pair of wheels.

16. The modular power source of claim 15, further comprising a generator, wherein the internal combustion engine is configured to drive the generator to produce electricity.

17. The modular power source of claim 16, further comprising a wire harness configured to be connected to the battery electric vehicle, wherein the electricity from the generator is provided through the wire harness to a battery of the battery electric vehicle.

18. The modular power source of claim 14, wherein the subframe is configured to mount to both frame rails of the vehicle frame having two frame rails extending longitudinally along a length of the battery electric vehicle and two or more cross-members joining the two frame rails.

19. The modular power source of claim 18, wherein the subframe comprises at least one subframe cross member, and wherein when the subframe is attached to the vehicle frame, the at least one subframe cross member spans the two frame rails of the vehicle frame.

20. The modular power source of claim 19, wherein the at least one subframe cross member comprises a receiver tube for receiving at least one of a ball mount or hitch-mount accessory.
